(19) United States
(12) Patent Application Publication
(10) Pub. No.: US 2006/0187296 A1
(43) Pub. Date: Aug. 24, 2006

(54) Method of producing a printing form

(75) Inventor: Thomas Rupp, Heidelberg (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/361,593

(22) Filed: Feb. 24, 2006

(30) Foreign Application Priority Data
Feb. 24, 2005 (DE) 10 2005 008 427.3

(51) Int. Cl. G01D 15/14; B41J 2/435; H01J 29/70; H01J 33/00

(52) U.S. Cl. 347/229

(57) ABSTRACT

A novel method of imaging a printing form renders possible a flexible adjustment of the resolution to a printing image. A number of equidistantly spaced radiation sources are selected from an array of radiation sources arranged along a straight line. The number of the image dots, which are to be written within the spacing distance of two neighboring radiation sources is determined in accordance with the resolution to be produced. A feed of the array is derived from the number of the image dots and the number of the selected radiation sources per rotation of the printing form blank. The radiation power of the selected radiation sources is adjusted in accordance with the number of the image dots and the imaging characteristics of the printing form blank.

### BACKGROUND OF THE INVENTION

### Field of the Invention

The invention lies in the printing technology field. More specifically, the invention relates to a method of producing a printing form. During a rotation of a printing form blank with predetermined imaging characteristics and a displacement of an array of equally spaced-apart radiation sources, the radiation sources are driven in an image-compliant manner in parallel direction to the rotary axis of the printing form blank. Image dots and non-image dots are selectively produced at the surface of the printing form blank in a predetermined resolution and by adjusting the radiation power of the radiation sources with a predetermined value.

For manufacturing a printing form, it has become known from the commonly assigned German published patent application DE 100 31 915 A1 and its counterpart U.S. Pat. No. 6,784,912 to produce image dots or no image dots on a printing-form blank by an array of a multiplicity of individually and imagewise controllable laser diodes. A printing-form blank or a non-imaged printing foil is clamped on the jacket surface of a drum or a printing form roller by an external drum imagesetter or by an imaging arrangement in a printing press and set into rotation. The laser diodes are disposed with equal spacing along a straight line that extends parallel to the rotational axis of the drum and of the printing form cylinder, respectively. The laser diode array is disposed in an imaging head which is displaced by a worm drive at uniform speed in a direction parallel to the rotational axis. Helical or spiral imaging tracks result. Per rotation or revolution of the drum and of the printing-form cylinder, respectively, the feed of the imaging head is smaller than the entire width of the laser diode array. The amount of displacement of the imaging head is greater than the spacing between image dots that are producible adjacent one another. Due to the fixed spacing of the laser diodes to one another and due to the fixed prescribed feed of the imaging heads, a resolution in the printing image can be achieved precisely.

The term “resolution” as used herein means the number of the producible image points per unit length in the feed direction of the imaging head. In this regard, the laser output or power is adjusted or set so that the size of an image dot affords a dense or close imaging.

Limiting the system to only one resolution is disadvantageous, because in imaging another image may advantageously call for a different resolution in the imaging process.

### SUMMARY OF THE INVENTION

It is accordingly an object of the invention to provide a method of producing a printing form, which overcomes the above-mentioned disadvantages of the heretofore-known devices and methods of this general type and which renders possible an adjustment of the resolution to the requirements of a given printing image.

With the foregoing and other objects in view there is provided, in accordance with the invention, a method of producing a printing form, which comprises:

rotating a printing form blank with predetermined imaging characteristics about an axis of rotation and displacing an array of equidistantly spaced-apart radiation sources in a direction parallel to the axis of rotation, while driving the radiation sources in accordance with an image to be formed, and thereby producing image dots or non-image dots at a surface of the printing form blank;

selecting a number of radiation sources disposed along a straight line at an equal spacing distance;

determining a number of image dots to be written within a spacing distance of two adjacent radiation sources in accordance with a resolution to be produced;

deriving an indexing feed of the array from the number of image dots and the number of radiation sources per rotation of the printing form blank; and

adjusting a power of the selected radiation sources in accordance with the number of the image dots and the imaging characteristics of the printing form blank.

In other words, in a first step, a number of radiation sources having a given spacing from one another are selected from a multiplicity thereof disposed at regular spacing along a straight line. If a given resolution is prescribed for a printing image, there is determined, in a next step, a number of dots which are described at a distance corresponding to the spacing of pairs of adjacent radiation sources. In a further step, the feed of the selected radiation sources per rotation of a printing form blank which has been set into rotation is calculated. Finally, in a succeeding step, the radiation output of the radiation sources is adjusted so that, by controlling the radiation sources one image dot on the printing form blank, a suitable size corresponding to the resolution is achieved. The radiation sources produce Gaussian waves which, due to the profile thereof at a change in the power output, exhibit a clear change in the size of the image dots.

The method permits a stepwise adjustment of the resolution to a printing image which is to be produced. The step width or breadth results from the spacing of the radiation sources selected for the imaging. The radiated power to be set or adjusted is dependent upon the characteristics of the printing form blank which, under the circumstances, are determined experimentally beforehand.

In accordance with a concomitant feature of the invention, laser diodes are used as the radiation sources.

Other features which are considered as characteristic for the invention are set forth in the appended claims.

Although the invention is illustrated and described herein as embodied in a method of producing a printing form, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of a printing unit with an integrated imaging device;

FIGS. 2A and 2B are schematic views illustrating the distribution of image dots between two laser diodes for two different resolutions; and

FIG. 3 is a table with correlations of spacing and power of laser diodes for a prescribed resolution in the image.

### DESCRIPTION OF THE PREFERRED EMBODIMENTS

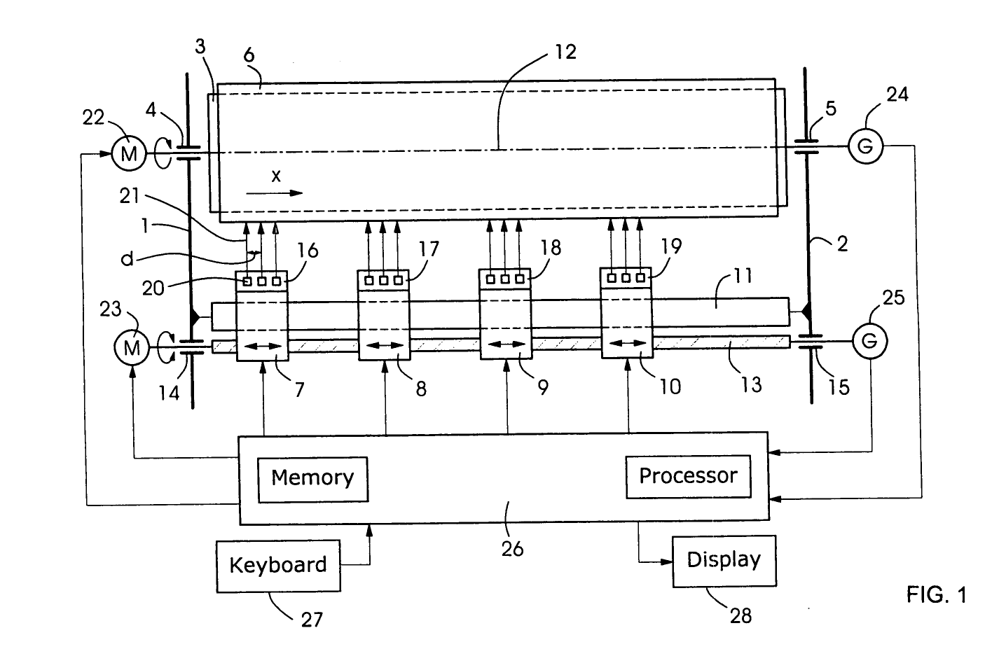

Referring now to the figures of the drawing in detail and first, particularly, to FIG. 1 thereof, there is seen a schematic view of a printing unit of a press with an integrated imaging device. A printing form cylinder is rotatably held in bearings 4, 5 between side walls 1, 2. A printing form blank 6 is clamped on the printing form cylinder 3. Four imaging heads 7-10 are provided for producing printing ink-accepting image dots on the surface of the printing form blank 6. The imaging heads 7-10 are arranged on a longitudinal guide 11. The longitudinal guide lies parallel to a rotational axis 12 of the printing form cylinder 3. The imaging heads 7-10 are positionable together with a spindle drive 13 in the direction of the rotational axis 12. The spindle drive is rotatably held in bearings 14, 15 in the side walls 1, 2.

The imaging heads 7-10 contain laser diode arrays 16-19 including optically image-forming elements. A laser diode array 16-19 encompasses n=64 individually controllable laser diodes 20, which are aligned along a line parallel to the rotational axis 12. The spacing d=160 μm of the laser diodes 20 in the direction of the rotational axis 12 is greater than the minimal spacing of a pair of image dots to be produced. When controlling a laser diode 20, a laser beam is formed perpendicularly to the rotational axis 12.

The printing form cylinder 3 and the spindle drive 13 are coupled, respectively, with motors 22, 23 and rotary transmitters 24, 25. The imaging heads 7-10, the motors 22, 23 and the rotary transmitters 24, 25 are connected to a control device 26. The control device 26 has processing and computing devices for controlling the printing press during printing and imaging. A keyboard 27 permits input of data by operating personnel. A display screen 28 serves for indicating control information.

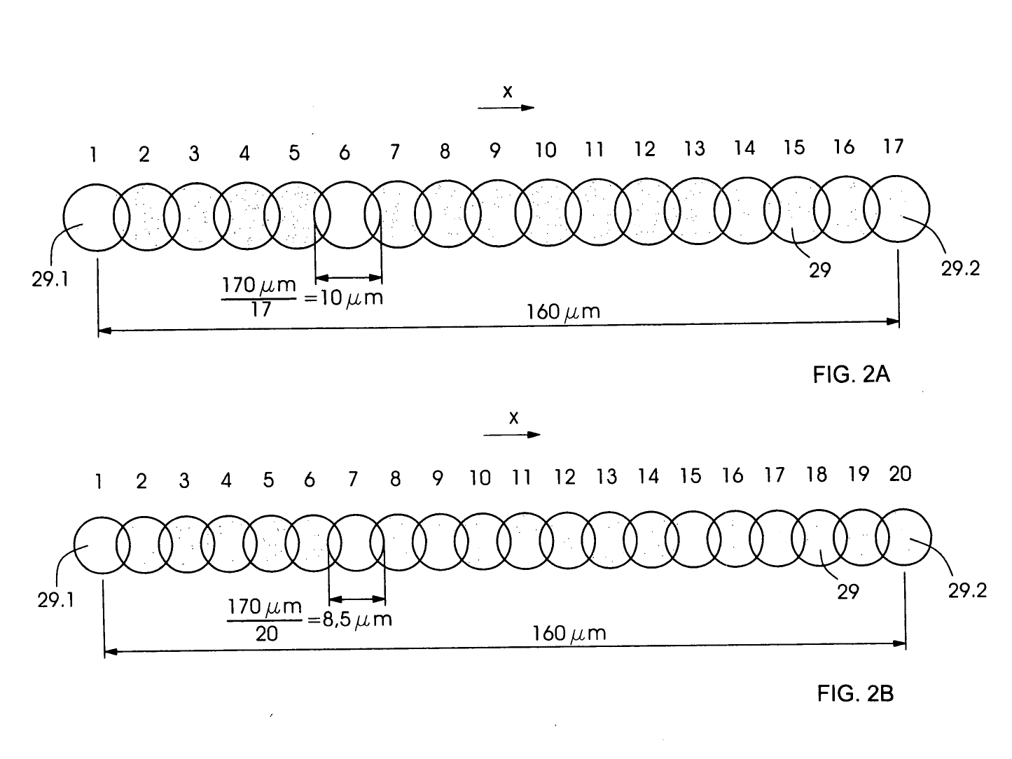

FIGS. 2A and 2B illustrate image dots 29 generated in an x-direction next to each other onto the printing form blank 6 at resolutions of 2540 dpi and 2988 dpi. The acronym “dpi” designates a number of image dots 29 per inch. The image dots 29.1, 29.2 lying outside were written by two neighboring laser diodes 20.

If the laser diodes 20 are chosen in the smallest possible distance d=160 μm, then the resolution of 2540 dpi results from writing p=17 image dots 29 on the path d=160 μm. The use of 64 laser diodes 20 results in a feed or index spacing v=640 μm of the imaging heads 7-10 per rotation of the printing form cylinder 3. The size of an image dot 29 is adjusted such that neighboring image dots 29 easily overlap. In the case illustrated in FIG. 2A, an image dot 29 is 10 μm in diameter. The radiation power of the laser diodes 20 is adjusted therefor to 90 mW.

At a resolution of 2988 dpi, twenty image dots 29 fit onto the path d=160 μm. The feed v of the imaging heads 7-10 then results in 544 μm per rotation of the printing form cylinder 3. The image dots 29 are to be written in a diameter of 8.5 μm, wherefore the laser diodes 20 are adjusted to a power of 77 mW.

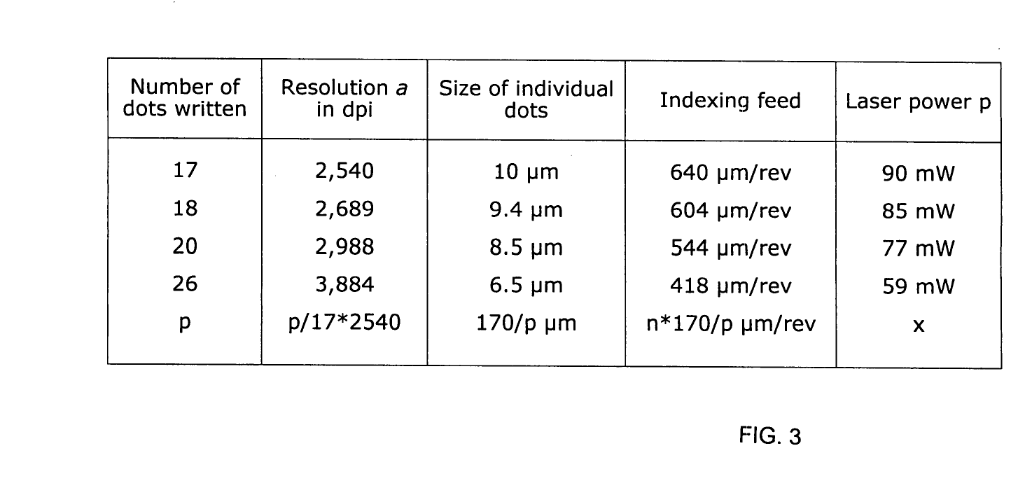

FIG. 3 shows a table with four different resolutions and assigned values for the diameter of the image dots 29, the index or feed of the imaging heads 7-10 and the radiation power of the laser diodes 20. At a predetermined distance d=160 micrometer of the laser diodes 20, the resolution a can be modified in steps of 2540/(d/10). The resolution a results from the following relationship:

$$a = \frac{p}{17} * 2540$$

wherein p is the number of image dots 29 in the distance d of two laser diodes 20. The diameter of a single image dot 29 is computed from

$$\frac{d}{p} = \frac{170 μ m}{p}$$

The feed of the imaging heads 7-10 results from

$$V = \frac{n * d}{p} = \frac{64 * 170}{p} \cdot \frac{μ m}{revolutions}$$

wherein n is the total number of laser diodes 20 in a laser diode array 16-19. The power p diminishes with an increasing resolution a. The power p is dependent upon the thermal sensitivity or the photo-sensitivity of the material, to be imaged, of the printing form blanks 6. The power values p for achieving a specific image dot diameter are determined experimentally.

This application claims the priority, under 35 U.S.C. § 119, of German patent application No. 10 2005 008 427.3, filed Feb. 24, 2005; the entire disclosure of the prior application is herewith incorporated by reference.

I claim:

1. A method of producing a printing form, which comprises:
rotating a printing form blank with predetermined imaging characteristics about an axis of rotation and displacing an array of equidistantly spaced-apart radiation sources in a direction parallel to the axis of rotation, while driving the radiation sources in an image-compliant manner, and thereby producing image dots or non-image dots at a surface of the printing form blank;
selecting a number of radiation sources disposed along a straight line at an equal spacing distance;
determining a number of image dots to be written within a spacing distance of two adjacent radiation sources in accordance with a resolution to be produced;
deriving an indexing feed of the array from the number of image dots and the number of radiation sources per rotation of the printing form blank; and
adjusting a power of the selected radiation sources in accordance with the number of the image dots and the imaging characteristics of the printing form blank.

2. The method according to claim 1, which comprises irradiating with laser diodes forming the radiation sources.
